(19) United States
(12) Patent Application Publication
(10) Pub. No.: US 2024/0135308 A1
(43) Pub. Date: Apr. 25, 2024

(54) METHOD AND SYSTEM FOR DISPLAYING A SEQUENCE OF TRUCK IDENTIFIERS TO TRUCKS

(71) Applicant: COMMAND ALKON INCORPORATED, Birmingham, AL (US)

(72) Inventors: Nycole GIANNOTTI, Birmingham, AL (US); Jennifer NICHOLAS, Birmingham, AL (US)

(21) Appl. No.: 18/494,447

(22) Filed: Oct. 24, 2023

Related U.S. Application Data
(60) Provisional application No. 63/419,247, filed on Oct. 25, 2022.

(51) Int. Cl. G06Q 10/0833; G06Q 50/30

(52) U.S. Cl. CPC G06Q 10/0833; G06Q 50/30

(57) ABSTRACT

There is described a method of displaying a sequence of truck identifiers at a plurality of truck computers. Each truck computer having a corresponding display screen and being located at a corresponding truck. Each truck computer having a respective one of said truck identifiers of the sequence. The method generally having: at a producer computer located at a batch plant, communicating the sequence of truck identifiers to a coordinator computer over a telecommunications network; at the coordinator computer remote from the batch plant, communicating the sequence of truck identifiers to corresponding ones of the plurality of truck computers associated to corresponding ones of the truck identifiers over the telecommunications network; and at different ones of the truck computers, displaying the sequence of truck identifiers on the associated display screen.

### CROSS-REFERENCE TO RELATED APPLICATIONS

This application claims priority to U.S. Provisional application No. 63/419,247 filed Oct. 25, 2022, the contents of which are hereby incorporated by reference in their entirety.

### TECHNICAL FIELD

The specification relates to the field of fresh concrete production, handling, and delivery and more particularly relate to facilitating transit of trucks at a batch plant

### BACKGROUND OF THE INVENTION

Fresh concrete is formed of a mixture of ingredients typically including cement, aggregate and water in given proportions, but there are various recipes and many of these include additional ingredients. The ingredients are typically transported inside a rotary drum of a concrete mixer truck where the fresh concrete mixture can be mixed and then continuously agitated prior to being unloaded at a job site. An example of such a mixer truck is shown in FIG. 1. Fresh concrete is a perishable rheological substance, its slump and temperature typically evolve over time and this evolution can eventually make the fresh concrete unusable for its intended purpose, or require introduction of additives or water. Agitation by the rotation of the drum and internal paddles is significant in preserving the freshness of the concrete during transport, but has its limits.

Around many American cities, and cities throughout the world, it is typical to have a number of job sites in simultaneous operation, requiring high volumes of fresh concrete of same or differing requirements, and the operations involving fresh concrete can be relatively complex. For instance, different job sites can be associated to a same, or different buyers (customers). There can be a number of batch plants, associated to a same or different producers, available for fulfilling customer requests and filling mixer trucks with suitable fresh concrete. Different batch plants can offer different selections of “recipes” (combinations of relative concentrations of ingredients) of concrete. In an additional layer of complexity, the mixer trucks may be managed by yet a third party, commonly referred to as a hauler, though in some cases the mixer trucks can be the property of the buyer or of the producer (in which case the buyer or producer may have their own hauling unit in addition to the respective buying or producing unit), and it can be required for the truck management entity to communicate with the trucks and to collect information from the trucks such as current location, and to communicate such information for the purpose of efficiency in attributing tasks to different trucks as a function of evolving conditions. In any given day, many different orders can be transacted in parallel, giving rise to several communications between buyers, producers and mixer trucks, such as schematized in FIG. 2. Various elements of technology are used to facilitate these different operations, giving rise to a relatively complex technological environment. While existing technology was satisfactory to a certain extent, there remained room for improvement.

### BRIEF SUMMARY OF THE INVENTION

An order is typically placed by a buyer. Typically, though not always, the buyer is more concerned about specifications of the concrete than by the details of the exact recipe. The order can thus be based on specifications which may make abstraction of the exact recipe. Such specifications typically set a minimum strength for the concrete but depending on the circumstances, the specifications may set a number of additional parameters such as aggregate size, water content, or other specific conditions. Orders also specify a required quantity of concrete. Given the perishable nature of concrete and operations at the job sites, orders also typically set timing to a certain extent.

Making things somewhat even more complicated, to satisfy the order, a dispatcher may serve as an intermediary between buyers (job sites) and producers (batch plants). The dispatcher can be associated to the buyer, associated to a producer, or a third party for instance. The dispatcher may establish a match between the specifications of a job ticket and one or more of the recipes which are made available by a given batch plant. The dispatcher may provide this information to truck management, and the latter may be responsible for identifying a truck responsible for fulfilling the order, or the dispatcher may have this latter responsibility and communicate the identification of the truck which has been attributed to truck management. The dispatcher and the truck manager may be a same or different entities and different functions or tasks can be shared differently between the dispatcher and the truck manager in different scenarios or embodiments.

Over the last decades, technology has been increasingly helpful in facilitating the various communications and other functionalities, and has led to an increasingly digitalized environment. In a digitalized environment, various communications between buyer, producer, and trucks, can be performed via different computers having appropriate software and hardware which communicate to one another over a telecommunications network such as the Internet. A higher level diagram representing an example scenario of such as digitalized environment is presented in FIG. 3.

As shown in FIG. 3, different instances of “buyer computer(s)” can be associated to different “buyers”, different instances of “producer computer(s)” can be associated to different “producer(s)” (or batch plants, equivalently), different instances of “truck computer(s)” can be associated to different trucks, and one or more “coordinator computer(s)” can be associated to one or more dispatchers and/or one or more truck manager (e.g., hauler or hauling unit). The buyer computers can be at corresponding job sites or buyer premises, the producer computers can be at corresponding batch plants or batch plant premises, the truck computers can be in different trucks (e.g., a tablet), and the dispatch computer can be a server located at dispatch premises, at hauler premises, or in the cloud (e.g. at the premises of a cloud service provider). The expression “layer” can be associated to different ones of these computers to refer to the typically but not necessarily software-implemented digital instances which communicate with one another independently of the details of their exact hardware and software configuration. The simplified expression “coordinator computer” is used here to refer to computer hardware and software which has one or more function associated to a dispatcher, a truck manager, or both, even though it will be understood that some functions in this layer may be performed by different entities in some embodiments.

A scheme such as represented in FIG. 3 can include protocols designed to facilitate the various communications between the buyer(s), the batch plant(s), and the truck(s) or hauler(s). Coordination schemes designed to facilitate communications between buyer(s), producer(s) (batch plants) and truck(s) can involve truck sensors and computers configured to communicate with one another over a telecommunications network such as the Internet. Coordination schemes can further include a coordinator computer configured to act as an intermediary to some or all of the communications between the parties involved. A coordinator computer can include a plurality of software and/or hardware layers. Such a coordinator computer can include a plurality of software applications running or otherwise providing input and output functionalities on different computers associated to the parties involved.

In such a digitalized environment, the buyer can use a buyer computer to order concrete from the producer, in which case the buyer computer can interface with the coordinator computer running dispatcher functions, such as via a telecommunications network. Specialized software at the buyer computer and/or at the coordinator computer can enable the buyer to make orders electronically in the form of data which can be referred to as job tickets. The job tickets can include the various specifications associated to the order including the concrete specifications, the job site location and the expected time of arrival. The task of associating corresponding trucks to associated job tickets can preferably be based on the information of current location of the trucks and/or their estimated travel time to a batch plant, and from the batch plant to the job site, and this type of information may be available to the truck manager functions based on a GPS or other automated location determination function associated to the trucks, and on the transmission of the information from the trucks to the truck manager functions of the coordinator computer.

It will be noted that mixer trucks are not the only trucks involved in the production and handling of fresh concrete. Indeed, flat-bed trucks, dump trucks, hauler trucks, to name some examples, can be responsible for carrying concrete ingredients to or from premises such as a batch plant, and the movements, pickups, and deliveries of such trucks may need to be coordinated as well. Accordingly, in this specification, the expression “truck” is used generally to cover various types of trucks.

Details presented heretofore pertaining to a digitalized environment can be satisfactory at many levels, such as productivity, to the point where it has become impossible in many cases to imagine operating at the same or similar rhythm with a comparable level of efficiency without the use of technology. However, there always remains room for improvement.

In accordance with a first aspect of the present disclosure, there is provided a method of displaying a sequence of truck identifiers at a plurality of truck computers, each truck computer having a corresponding display screen and being located at a corresponding truck, each truck computer having a respective one of said truck identifiers of the sequence, the method comprising: at a producer computer located at a batch plant, communicating the sequence of truck identifiers to a coordinator computer over a telecommunications network; at the coordinator computer remote from the batch plant, communicating the sequence of truck identifiers to corresponding ones of the plurality of truck computers associated to corresponding ones of the truck identifiers over the telecommunications network; and at different ones of the truck computers, displaying the sequence of truck identifiers on the associated display screen.

In accordance with a second aspect of the present disclosure, there is provided a system for displaying a sequence of truck identifiers to a plurality of mixer trucks, the system comprising: a producer computer located at a batch plant; a coordinator computer remote from the batch plant; and a plurality of truck computers each having a corresponding display screen and being located at a corresponding mixer truck of the plurality of mixer trucks, each truck computer having a respective one of the truck identifiers of the sequence, the producer computer being configured for communicating the sequence of truck identifiers to the coordinator computer over a telecommunications network, the coordinator computer being configured for communicating the sequence of truck identifiers to the plurality of truck computers over the telecommunications network, the plurality of truck computers displaying the sequence of truck identifiers on the associated display screen.

In accordance with a third aspect of the present disclosure, there is provided a system for displaying a sequence of truck identifiers to a plurality of mixer trucks, each mixer truck having a respective truck identifier, the system comprising: a transmitter device having a cable connected to a batch panel, and a first communication module commutatively coupled to the cable, the first communication module receiving a current sequence of truck identifiers from the batch panel via the cable and transmitting the current sequence of truck identifiers to a telecommunications network; a coordinator computer receiving the current sequence of truck identifiers from the first communication device via the telecommunications network; and a plurality of truck computers being mounted to corresponding ones of the plurality of mixer trucks, the truck computers each having a second communication module receiving the sequence of truck identifiers from the coordinator computer via the telecommunications network, and a display screen displaying the current sequence of truck identifiers in real time.

In accordance with a fourth aspect of the present disclosure, there is provided a method for displaying a sequence of truck identifiers to a plurality of truck computers, each mixer truck having a respective truck identifier, the method comprising: using a transmitter device being communicatively coupled to a port of a batch panel, receiving a current sequence of truck identifiers from the batch panel and transmitting the current sequence of truck identifiers to a telecommunications network; using a coordinator computer communicatively coupled to the telecommunications network, receiving the current sequence of truck identifiers from the transmitter device via the telecommunications network and relaying the current sequence of truck identifiers to a plurality of truck computers each being mounted to corresponding ones of the plurality of mixer trucks; and the plurality of truck computers having corresponding display screens displaying the current sequence of truck identifiers in real time.

In accordance with a fifth aspect of the present disclosure, there is provided a system for displaying a sequence of truck identifiers to a plurality of truck computers at a batch plant, the system comprising: a transmitter device having a conductor connected to a batch panel, and a first communication module commutatively coupled to the conductor, the first communication module receiving a current sequence of truck identifiers from the batch panel via the conductor and transmitting the current sequence of truck identifiers over a telecommunications network; and a plurality of truck computers being mounted to the plurality of mixer trucks, the truck computers having a second communication module receiving the sequence of truck identifiers from the first communication module via the telecommunications network, and a display screen displaying the sequence of truck identifiers in real time.

In accordance with another aspect, there is provided method for communicating a sequence of truck identifiers corresponding to a load queue of trucks at a batch plant to drivers of the trucks, wherein each truck has a truck computer authenticated with a coordinator computer via a truck identifier, the coordinator computer remote from the batch plant, the method comprising: at each truck computer, receiving, from the coordinator computer, the sequence of truck identifiers, reading the sequence of truck identifiers, and displaying the truck identifiers forming part of the sequence, including the respective truck identifier of each truck computer, on a display screen in the corresponding driver's field of vision.

In accordance with another aspect, there is provided a method for communicating a sequence of truck identifiers corresponding to a load queue of trucks at a batch plant to drivers of the trucks, wherein each truck has a truck computer authenticated via a corresponding one of the truck identifiers, the method comprising: at a coordinator computer, receiving a plurality of sequences of truck identifiers from different producer computers, reading each one of the plurality of sequences of truck identifiers to determine to which truck identifier each sequence of truck identifiers pertains, and communicating each one of the plurality of sequences to each one of the truck computers authenticated via a truck identifier to which the sequence of truck identifiers pertains.

In accordance with another aspect, there is provided a method for communicating a sequence of truck identifiers corresponding to a load queue of trucks at a batch plant to drivers of the trucks, the method comprising: at a producer computer located at the batch plant, acquiring the sequence of truck identifiers from a batch panel located at the batch plant, via a serial wired connection between the producer computer and the batch panel; at the producer computer, transmitting the sequence of truck identifiers to a coordinator computer over a telecommunications network.

It will be understood that the expression “computer” as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit.

It will be understood that a computer can perform functions or processes via hardware or a combination of both hardware and software. For example, hardware can include logic gates included as part of a silicon chip of a processor. Software (e.g., application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. A processor, controller, and/or memory can be local in some embodiments, or partially or entirely remote, distributed and/or virtual in other embodiments.

Many further features and combinations thereof concerning the present improvements will appear to those skilled in the art following a reading of the instant disclosure.

### BRIEF DESCRIPTION OF THE DRAWINGS

In the figures,

FIG. 1 is a schematic view of an example of a concrete mixer truck, shown with a truck computer in a cabin thereof, in accordance with one or more embodiments;

FIG. 2 is a schematic view of an example interaction scheme between parties involved in the delivery of a fresh concrete load to a job site;

FIG. 3 is a schematic view of example software layers and data flows which can be used to facilitate or implement some or all of the interactions between parties involved in the delivery of a fresh concrete load to a job site;

FIG. 4 is an image of a load board present at a batch plant for displaying a sequence of truck identifiers, in accordance with one embodiment;

FIG. 5 is a schematic view of an example system for displaying a sequence of truck identifiers to truck computers, shown with a producer computer, a coordinator computer and a truck computer, in accordance with one or more embodiments;

FIG. 6 is a schematic view of an example of a truck computer, shown with a display screen displaying a sequence of truck identifiers, in accordance with one or more embodiments;

FIG. 7 is a schematic view of an example of a computing device of one of the producer, coordinator and truck computers of FIG. 5, in accordance with one or more embodiments;

FIG. 8 is a schematic view of an example system for displaying a sequence of truck identifiers to truck computers, showing a batch panel communicatively coupled to a communication module, in accordance with one or more embodiments;

FIG. 9A is an elevation view of a display screen showing a first example graphical user interface for a truck computer;

FIG. 9B is an elevation view of a display screen showing a second example graphical user interface for a truck computer;

FIG. 9C is an elevation view of a display screen showing a third example graphical user interface for a truck computer;

FIG. 9D is an elevation view of a display screen showing a fourth example graphical user interface for a truck computer;

FIG. 10A is a geographical map showing hotspots delimiting areas into which the truck computer can initiate display of the sequence of truck identifiers, in accordance with one or more embodiments; and

FIG. 10B is a geographical map showing a geo-located gate across which truck computer can initiate or shut off display of the sequence of truck identifiers, in accordance with one or more embodiments.

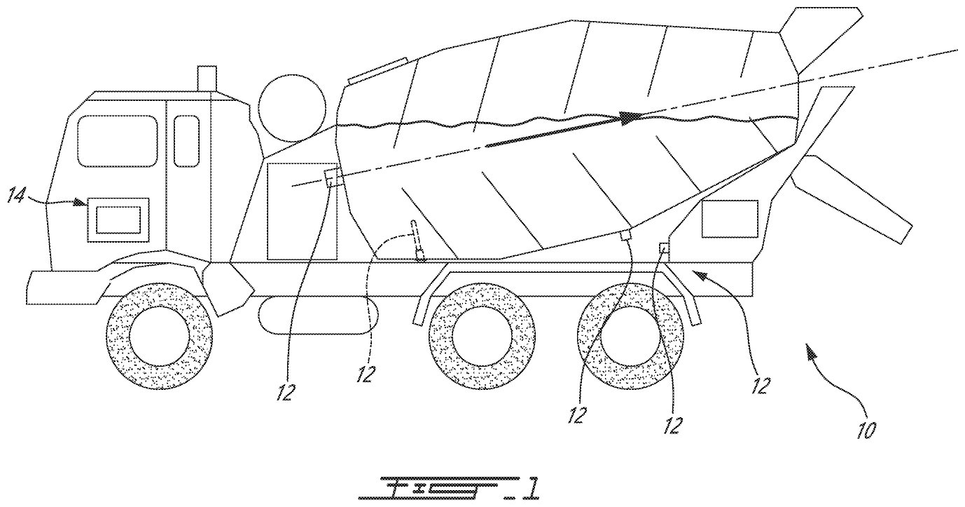

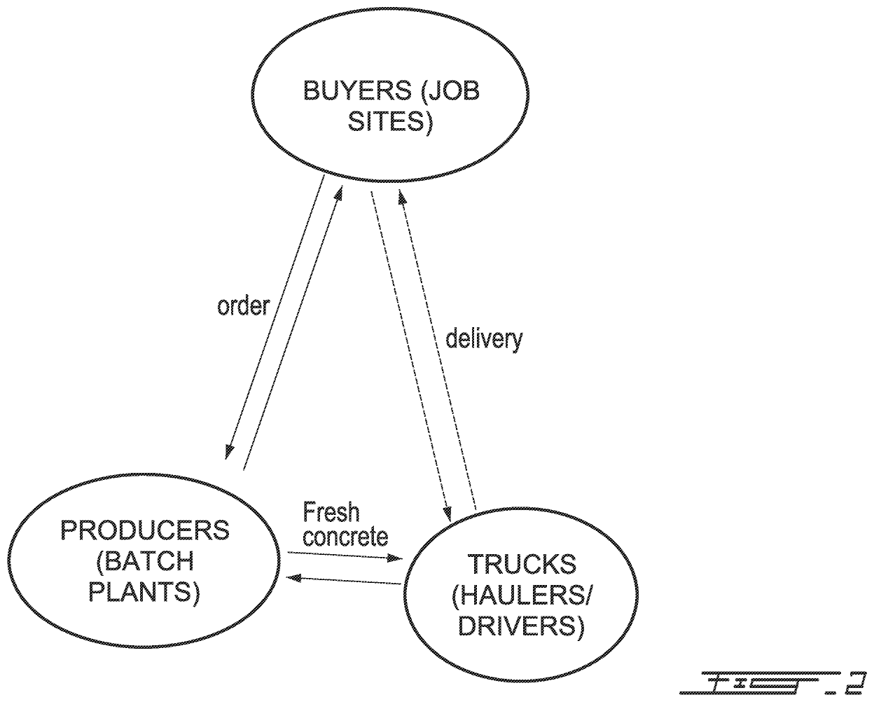

### DETAILED DESCRIPTION OF THE INVENTION

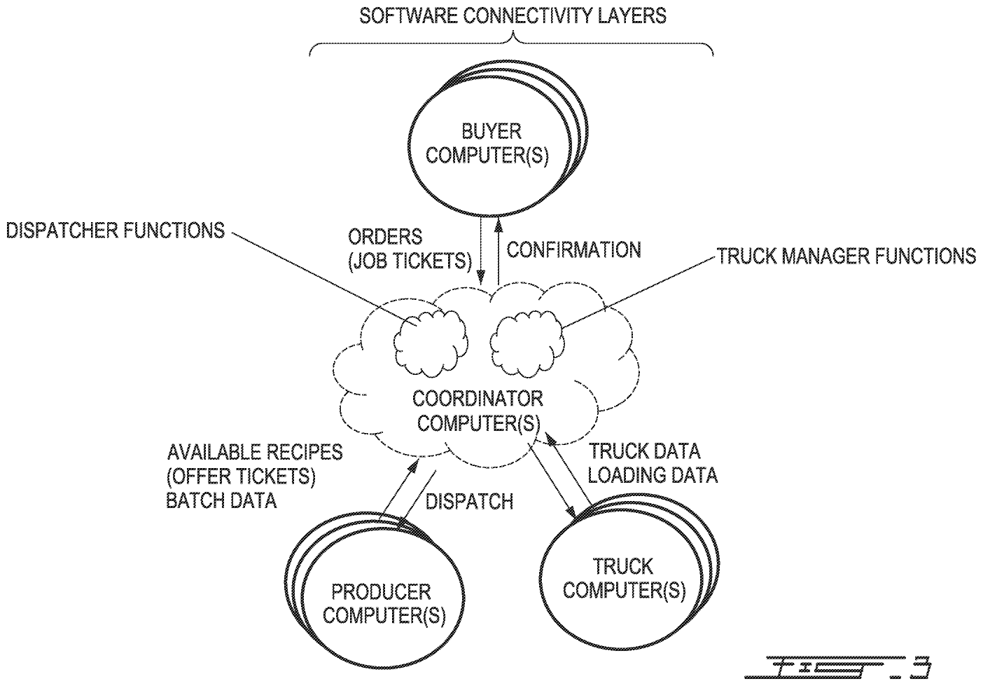

FIG. 3 presents an example of various elements of the digitalized environment associated to the production and handling of fresh concrete. In the example presented in FIG. 3, one or more coordinator computer is used to perform both dispatcher functions, e.g., associating an buyer order to a batch plant, and truck manager functions, e.g. directing a truck to fulfill the delivery. Referring to FIG. 3, when the coordinator computer is associating the order (job ticket) to a batch plant (producer) and to a mixer truck, it can be helpful for the coordinator computer to have access to information about the amount of time which would be expected for different ones of the trucks to do one or more of i) reach the batch plant, ii) receive the load once at the batch plant, and iii) travel to the job site with the load. For this reason, it can be relevant for current location information or time of travel information to be communicated by the truck computers to the coordinator computer. It can also be relevant for the coordinator computer to have access to location data pertaining to the location of the batch plant and the location of the job site. It can also be relevant for the coordinator computer to have access to data pertaining to an estimated wait or load time at a give batch plant. Truck manager functions of the coordinator computer can include authentication of the truck computers which may be achieved via a remote login process in which the truck computers establish a trusted communications channel with the coordinator computer. The login process can involve a truck identifier uniquely identifying the truck computer (and hence, the associated truck) amongst the different truck computers and a driver identifier which can include information about the truck driver such as name and potentially also communication coordinates such as a telephone number, an email address, a point to point communications identifier, etc.

Once the match is established, the transaction can proceed, and it may be desired to secure confirmation by the truck driver that he/she accepts the job ticket, and takes responsibility of its delivery, which again, may involve computerized communication between the truck driver and the coordinator computer via the truck computer. Suitable software may be provided both at the coordinator computer and at the truck computer to implement such communications and be associated with truck manager functions. Typically, once a transaction is agreed, the available mixer truck is expected to travel towards the given batch plant. In parallel, the coordinator computer may communicate the matched mixer truck's identifier and associated job ticket to the batch plant (producer computer) responsible for the order to allow the batch plant to begin planning for the loading operation. Again, in a digitalized system, such communications can involve suitable software elements provided both at the coordinator computer and at the producer computer.

When the dispatcher functions and the truck manager functions communicate, the truck manager functions can convey the truck identifier associated to a given order (job ticket) to the dispatcher functions. The dispatcher functions can communicate the truck identifier to the batch plant (producer computer) which has been associated to the job ticket.

In the highly technological era in which we live in, various configurations are possible for the implementation of the coordinator computer. In one example, the coordinator computer can be handled by a third party. The coordinator computer can operate on a server remote to both the buyer and producer computers. The coordinator computer can operate as a cloud-based platform, such as an AWS (Amazon web services) platform, and communicatively coupled to the truck computers and to the producer computers via the Internet.

Each batch plant typically receives a significant number of truck identifiers and associated job tickets during any given work day, and a number of trucks can be at the batch plant's premises or on their way at any point in time. The batch plant may be motivated to ensure that each incoming truck is being loaded with the correct recipe, and may also be motivated to avoid any undue delay in the loading process. From the batch plant's point of view, it may not be optimal for the trucks to be loaded on a first come, first served basis. In practice, an operator at the batch plant, commonly referred to as a “batchperson” (or batchman) is responsible for ultimately determining the load order. This can be performed using a specialized computer, typically referred to as the “batch panel,” and via which the batch person may determine the loading order (loading queue). The batch panel can have hardware which is entirely distinct from the hardware associated to what was referred to above as the producer computer, share hardware with the producer computer, or be the same device as the producer computer, depending on the details of a given embodiment, although at the time of filing this application, the batch panel was typically a distinct, standalone computer. To facilitate the batchperson's job, a default load order queue is typically provided at the batch panel, and the batchperson can alter the load order queue from the default load order queue to an other load order queue when he/she sees, given his understanding of the batch plant operations and the knowledge otherwise available to him, an opportunity to optimize the batch plant's operation on this basis. For instance, the fifth job ticket in line may be moved forward to the fourth position if it involves similar ingredients than the third job ticket, as it may be advantageous to prepare the batches for these two job tickets at the same time. As another example, if the recipes of two of the job tickets corresponding to waiting trucks differs solely by the addition of one or more ingredient, it may be preferable to mix both batches together, deliver the first one, add the additional ingredient(s), and then deliver the second one. In such a case, if the two associated trucks are separated by an intermediary truck in the initial queue order, the batchperson may prefer that approach to the initial queue order, and change the queue order for the two associated trucks to proceed in immediate succession. As such, the sequence by which the job tickets are being addressed can change on the go, adding a layer of challenge in managing the movements of the empty mixer trucks that have arrived at the batch plant and are waiting for their load. More specifically, this can create a requirement for the technological solution to provide for the possibility that the queue order may change in real time. Accordingly, the current load order queue of any given batch plant, embodied as a current sequence of truck identifiers in the digitalized environment, can be embodied as data which originates locally at the batch plant, and more specifically at the batch panel.

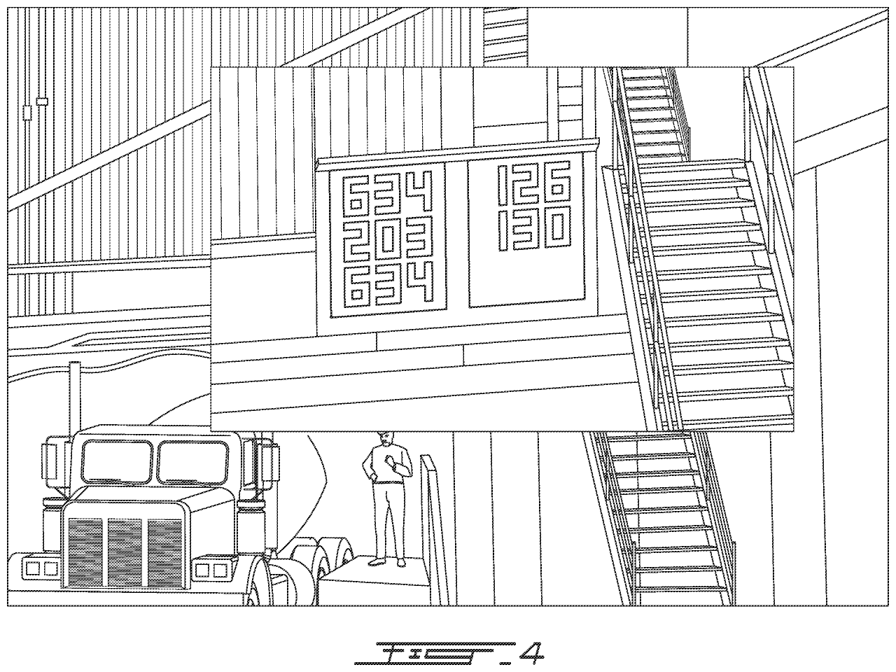

In many batch plants, circulation can be a challenge, and the occurrence of a truck going at the wrong place at the wrong time can cause significant production delays. To this end, the batch plant can wish to direct the mixer trucks. The information about the load queue can be relevant to communicate to the mixer trucks in this context. One way of communicating the load queue to the trucks is via a “load board,” an example of which is shown at FIG. 4. The load board can be embodied as a digital display screen connected to an output of the batch panel via a serial cable, from which it receives and can display the current sequence of truck identifiers of the next few trucks in the load queue. The load board can thus dynamically change the order of the truck identifiers in the load queue when a change in the load queue occurs at the batch panel, can add truck identifiers as new trucks reach the batch plant, and can remove truck identifiers when trucks have received their load.

There are several limits to the afore-mentioned “batch panel” approach. Firstly, load boards are provided outside and are thus exposed to the elements. They can wear over time and require maintenance (e.g., lights going out or wiring not sustaining weather-induced damage), and their acquisition and/or maintenance can represent significant costs to batch plants. Secondly, load boards are very local in nature, and for truck drivers to have access to the information displayed on the load board, they may need to move their mixer truck into close proximity with the load board, or even to a certain angle relative the load board, which can be a significant inconvenience in some cases, either in the form of loss of time for the truck driver or in the form of undesirably increased traffic in the vicinity of the load board where vantage points are found, for instance. Weather hazards such as rain or snow, or dirt covering some of the lights of the load board, can also obstruct the display. Accordingly, while the load board technology can be suitable to a certain extent, there remains room for improvement in the function of relaying the information contained in the sequence of truck identifiers originating at the batch panel to the truck drivers.

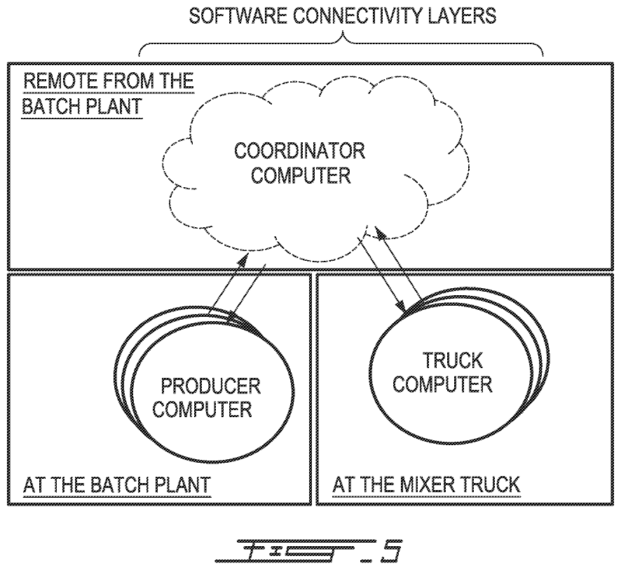

In some embodiments, some or all of such inconveniences can be addressed via a system for displaying a sequence of truck identifiers at the truck computers (e.g., electronic tablets) located inside the mixer trucks. As present in FIG. 5, the system can involve functions performed by one or more coordinator computer. More specifically, the system can communicate load order queue data originating at the batch plant in a computerized manner, over a telecommunications network, to a coordinator computer further having functions associated with truck management, and which may additionally have dispatch functions or not. The coordinator computer can further have a function to relay the load order queue data to individual ones of the trucks which are listed in the load order queue data, for instance.

Accordingly, in one example embodiment, a producer computer running a virtual instance of a producer layer can be provided with the information contained in the sequence of truck identifiers originating at the batch panel. Preferably, this information is communicated directly in the form of data in real time, and can thus be acquired directly from the batch panel by the producer layer. The producer layer can communicate the data to the coordinator computer, e.g., via the Internet or another suitable telecommunications means. The coordinator computer, then having simultaneously access to a) the batch plant identifier associated to the given batch plant and b) the load queue order including the sequence of truck identifiers, can relay the information over specifically to the mixer trucks associated to the truck identifiers listed in a specific sequence. The coordinator computer may selectively communicate the information specifically to the truck computers associated to the truck identifiers listed in a specific sequence and not communicate the information to other truck computers which may also be logged into trusted communication with the coordinator computer, such as other truck computers associated to trucks which have been attributed tickets associated to other batch plants, trucks which are awaiting the attribution of a ticket, and trucks which have been loaded and are on their way to job sites.

From that point on, a truck layer can implement a method of displaying a sequence of truck identifiers at truck computers including receiving the relevant load queue order from the coordinator computer. Each truck computer having a corresponding display screen and being located at a corresponding truck. Each truck computer having a respective one of the truck identifiers. The method has a step of, at different ones of the truck computers, displaying the sequence of truck identifiers on the associated display screen.

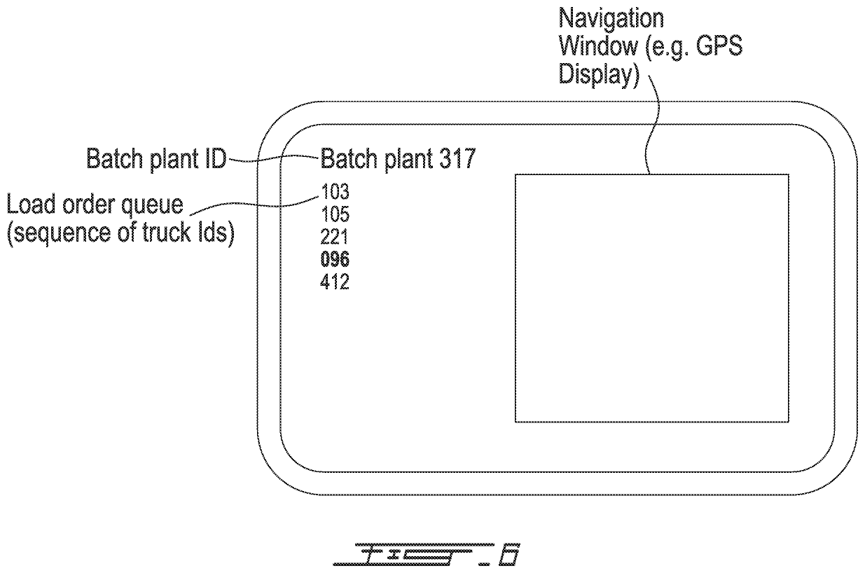

FIG. 6 shows an example of a truck computer, in accordance with an embodiment. As shown, the truck computer is provided in the form of a “tablet” having a graphical user interface in the form of a touch screen display screen which is configured for displaying the sequence of truck identifiers received from the coordinator computer. In some embodiments, the display screen may further display the batch plant identifier, and potentially other windows, such as a GPS navigation window for instance. As shown, each truck identifier can be a string of characters uniquely identifying the truck within a fleet of trucks. In some embodiments, the truck identifier is a series of numbers. In some embodiments, the truck identifier can be alphanumerical (a series of digits and letters). The truck identifier may be printed on an exterior surface of the concrete mixer truck 10 or be specific to the truck computer, which may be moved with a truck driver from one truck to another from one working day to another. The truck identifier may be stored on a memory of the truck computer.

In some embodiments, the coordinator computer is configured to communicate the sequence of truck identifiers only to the truck computers associated to the truck identifiers of the sequence. Accordingly, if there are fifty mixer trucks in a fleet, with only five of them at or travelling towards a given batch plant, the coordinator computer can limit the transmission of the sequence of truck identifiers to those five mixer trucks only. In some other embodiments, the producer computer can communicate a batch plant identifier to the coordinator computer. In these embodiments, the coordinator computer can communicate the batch plant identifier to the truck computers for display on the associated display screens. In this way, the truck drivers can have a glance at the truck computers and instantly read to which batch plant they are travelling to, for instance. The producer computer can also communicate loading information concerning a given truck identifier to the coordinator computer. In these latter embodiments, the coordinator computer can communicate the loading information to the truck computer associated to the given truck identifier for display on the associated display screen. Indeed, it was found that some information is only relevant to one of the trucks, accordingly the sharing of this information, such as the loading information, can preferably be limited to the concerned mixer truck. For instance, the loading information can include one or more of an estimated time until loading, a queue rank, an estimated time of loading, etc.

In some embodiments, it was found convenient for the truck computers to emphasize a display of their own respective truck identifiers of the sequence on the display screen. For instance, the emphasis can involve modifying at least one of a font, a style, colour and background colour of its associated truck identifier in the sequence, making the information of the driver's position in the queue more easily ascertainable from the display.

In some embodiments, the display of the sequence of truck identifiers can be dynamically updated in real time, based on updated information provided by the producer computer to the coordinator computer and by the coordinator computer to the truck computer. The update can be proactive, such as by the coordinator computer having a function of automatically “pushing” updated data over to the truck computers as this new data is made available, or reactive, such as being triggered by a truck driver pressing an “update” icon on the truck computer interface which triggers a request for updated information to the coordinator computer, which may then simply provide the information it already has to the truck computer or retrieve the information from the producer computer and relay it to the truck computer.

In some embodiments, each truck computer has an input device. In some embodiments, the display screen is provided in the form of a touch screen, and so the touch screen acts as both the display screen and the input device, such as in common electronic tablets. In these embodiments, it may be suitable to authorize access to the truck computer upon validating driver credentials inputted via the input device. For instance, the truck computer, or an application thereof, may not be accessible by a person until an authorized driver enters his/her own driver credentials. In some embodiments, the validation of the driver credentials is not performed on the truck computer, but rather at the coordinator computer, such as by logging in via the Internet. In these embodiments, the coordinator computer can have an accessible database of authorized truck drivers listing driver identifiers and corresponding driver credentials. Accordingly, upon receiving driver credentials from a given one of the truck computer, the coordinator computer can compare the inputted driver credentials to the database of authorized truck drivers and transmit an authorization signal (or error signal) to the corresponding truck computer based on the comparison. In some embodiments, as described in further detail below, each truck computer can be configured for displaying the current sequence of truck identifiers upon detecting that the truck computer has crossed a predetermined geographical gate.

Each one of the producer computer, the coordinator computer and the truck computer can be provided as a combination of hardware and software components configured to collaborate to perform associated functions. The hardware components can be implemented in the form of a computing device 700, an example of which is described with reference to FIG. 7. The producer computer, the coordinator computer and the truck computer can have an architecture such as the one of the computing device 700. Moreover, the software components of the producer computer, the coordinator computer and the truck computers can be implemented in the form of one or more software applications.

Referring to FIG. 7, the computing device 700 can have a processor 702, a memory 704, and I/O interface 706. Instructions 708 for running the one or more software applications can be stored on the memory 704 and accessible by the processor 702.

The processor 702 can be, for example, a general-purpose microprocessor or microcontroller, a digital signal processing (DSP) processor, an integrated circuit, a field programmable gate array (FPGA), a reconfigurable processor, a programmable read-only memory (PROM), or any combination thereof.

The memory 704 can include a suitable combination of any type of computer-readable memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

Each I/O interface 706 enables the computing device 700 to interconnect with one or more input devices, such as the batch panel, mixer truck's sensors, a user input, other computer(s), or with one or more output devices such as a graphical user interface, a memory system, a telecommunications network or other computer(s).

Each I/O interface 706 enables the producer, coordinator and truck computers to communicate with other components, to exchange data with other components, to access and connect to network resources, to server applications, and perform other computing applications by connecting to a telecommunications network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area telecommunications network, wide area telecommunications network, and others, including any combination of these.

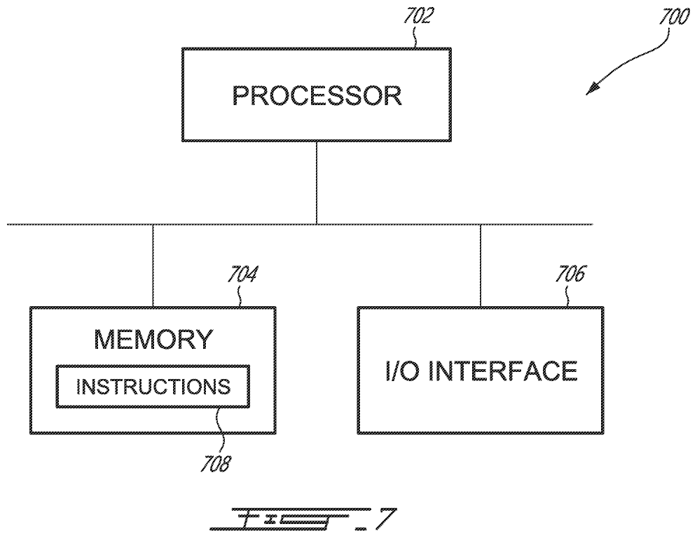

FIG. 8 shows an example of a system for displaying a sequence of truck identifiers to truck computers, in accordance with another embodiment. As discussed above, each mixer truck having a respective truck identifier which can be formed of letters, digits, and a combination of both. As depicted, the system has a transmitter device. The transmitter device is communicatively coupled to the batch panel of a corresponding batch plant. For instance, the transmitter device can have a cable connected to a port of the batch panel. The batch panel and the transmitter device can form a producer computer, in some embodiments. In some specific examples, the cable may be connected to a serial port of the batch panel. In one embodiment, the transmitter device can be provided in the form of hardware forming part of the producer computer. The serial port may be the port formerly used to connect to a physical load board discussed above, or any other suitable port. Moreover, as depicted, the transmitter device has a first communication module commutatively coupled to the cable. In this way, the communication module can receive a current sequence of truck identifiers from the batch panel via the cable. The current sequence of truck identifiers can thus be transmitted to a telecommunications network and more specifically to the coordinator computer. It is noted that, in some embodiments, the transmitter device has a conductor and first communication module connected to a batch panel in a way that the transmitter device can be said to be made integral to the batch panel. In this specific embodiment, the transmitter device which is located at the batch plant needs not to be a computer per se, but can be only a repeater, for instance.

As shown, the coordinator computer receives the current sequence of truck identifiers from the first communication device via the telecommunications network. The coordinator computer transmits the current sequence of truck identifiers to truck computers which are each mounted to corresponding mixer trucks. As shown, each truck computer has a second communication module receiving the sequence of truck identifiers from the coordinator computer via the telecommunications network, and a display screen displaying the current sequence of truck identifiers in real time. In the depicted embodiment, a wired connection is shown between the second communication module and the display screen, however this connection can be wireless in some other embodiments. Accordingly, if a current sequence of truck identifiers is truck identifier A then truck identifier B and then truck identifier C, the truck computers of the corresponding concrete mixer trucks A, B and C are configured to display the sequence of truck identifiers A then B and then C, e.g., A-B-C, A/B/C, A>B>C. If for any given reason, the batch plant operator decides to move the third truck before the second one, the current sequence of truck identifiers is changed on the go to truck identifier A then truck identifier C and then truck identifier B, or equivalently A-C-B, A/C/B, A>C>B. In this event, the system described herein can be used to modify the display in each of the truck computers, thereby announcing any recent change(s) and the updated sequence of truck identifiers to all the truck drivers.

In some embodiments, the producer computer is transmitting the current sequence of truck identifiers to the coordinator computer at a refresh rate of one time per minute, and more preferably once time per second or even faster. Similarly, the coordinator device can transmitting the current sequence of truck identifiers to the truck computers at a refresh rate of once time per minute, and more preferably once time per second. In some embodiments, the communication relationship between the producer computer and the coordinator computer is a push relationship in which the producer computer pushes the current sequence to the coordinator computer only when a change affects the sequence. Alternately, the communication relationship between the producer computer and the coordinator computer can be a pull relationship in which the coordinator computer queries the new current sequence to the producer computer at a given frequency or when desired. In some embodiments, the communication relationship between the coordinator computer and the truck computers is a push relationship in which the coordinator device pushes the current sequence to each one of the truck computers only when a change is made in the current sequence. Alternately, the communication relationship between the coordinator computer and the truck computers can be a pull relationship in which each one of the truck computers can query the new current sequence to the coordinator at a given frequency or when desired. In some embodiments, these communication relationships can be a combination of push and pull communications, depending on the embodiment. For instance, the default communication relationship can be a push communication between the producer computer and the coordinator computer and between the coordinator computer and the truck computers. However, when a truck driver triggers a refresh button using the user interface of the truck computer, queries to update the sequence can be sent up to the coordinator computer and then up to the transmitter layer to force a refresh of the current sequence.

It will be understood that the producer computer, and more specifically the producer layer, can be configured to communicate with the coordinator computer, or more specifically the coordinator layer, via a first application programming interface (API), and the coordinator computer can be configured to communicate with the truck computer via a second API.

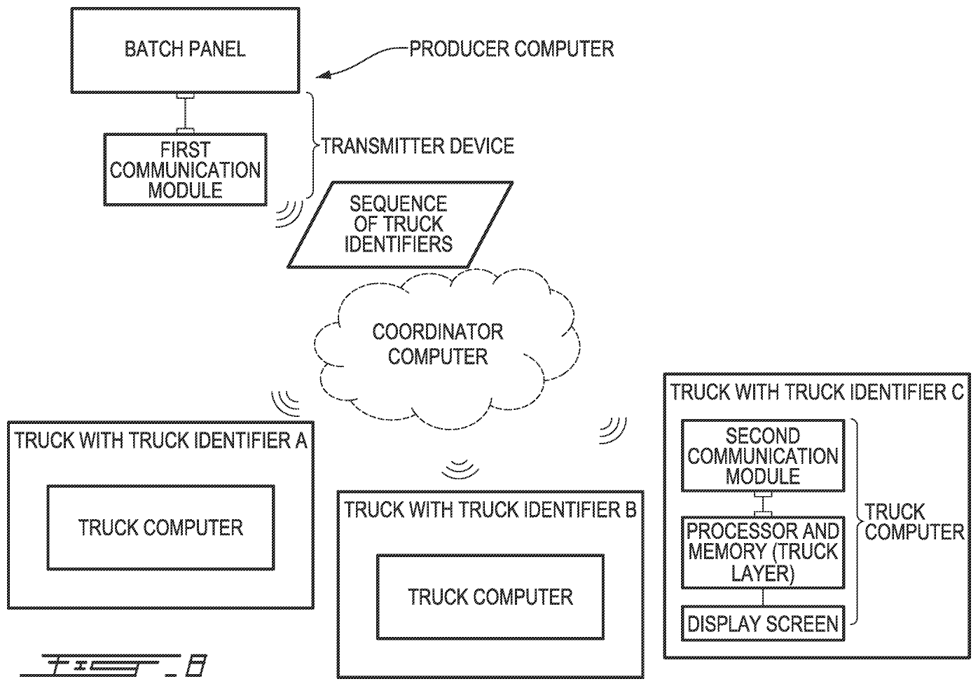

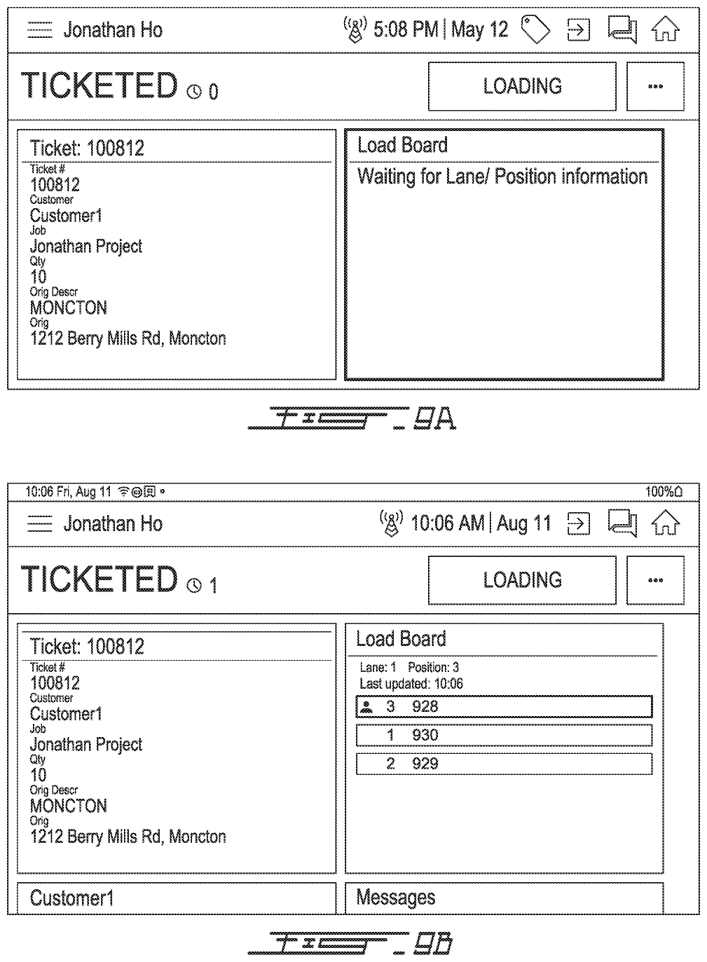

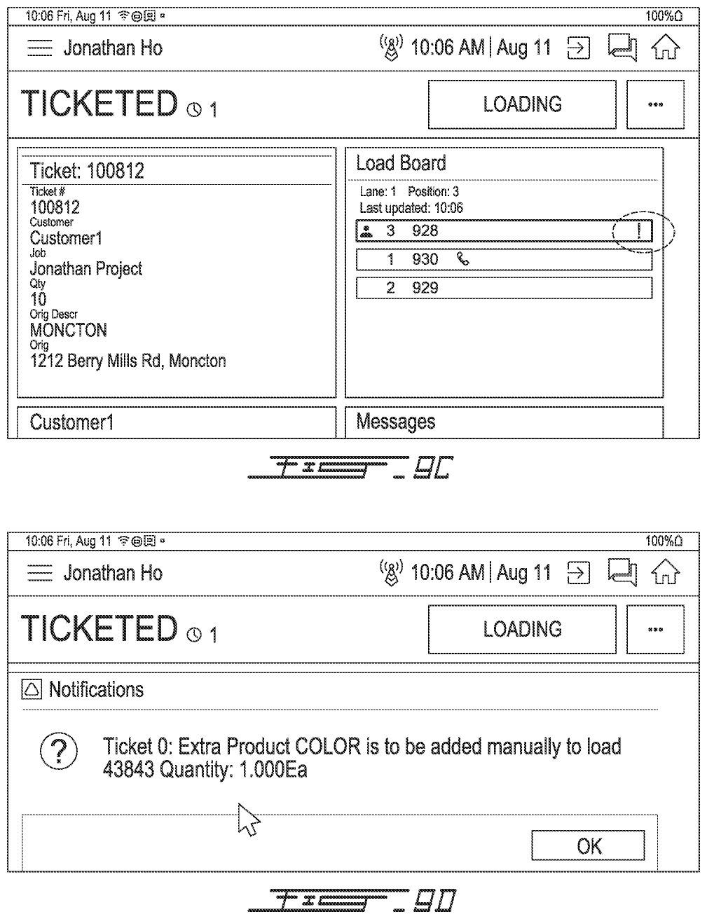

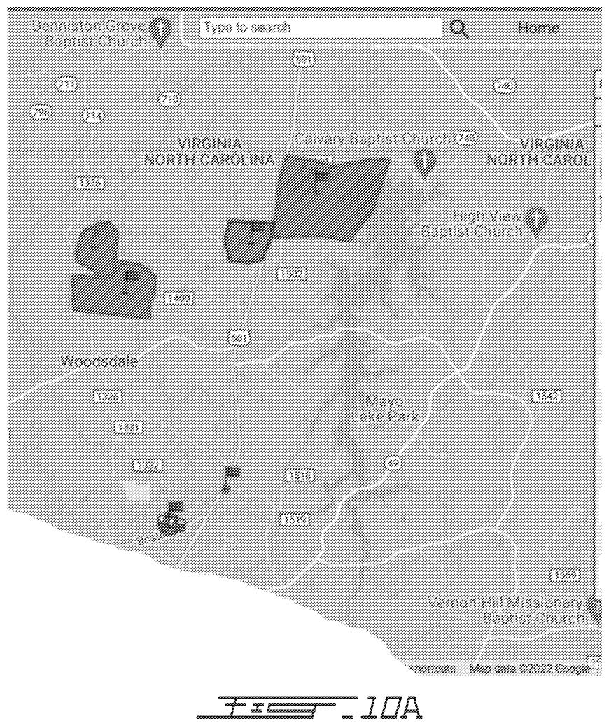

Reference is now made to FIG. 9A-9D which show an example of a graphical user interface displayed on the display screen of a truck computer. As shown, the truck computer is provided in the form of an electronic tablet having a frame enclosing the processor, the computer-readable memory and the second communication module. The electronic tablet also exposes a display screen which acts as a user interface as well, since the display screen is a touch screen in this example. It will be understood that a mouse or joystick can be used to select a given part of the screen instead of a touch screen in an alternate embodiment.

FIG. 9A presents the graphical user interface when the truck computer has been attributed a job ticket (ticketed), but has not yet received load board data. In this example, details pertaining to the job ticket can be displayed in a window occupying a left hand side of the screen.

FIG. 9B presents the graphical user interface when the truck computer has received the load board data including a sequence of truck identifiers, and displays the information on the display screen. In this example, details pertaining to the sequence of truck identifiers can be displayed in a corresponding window, which in this case, occupies a right hand side of the screen. It will be noted that in this specific example, the truck layer of software is configured to always display its associated truck first in the list of truck identifiers of the sequence, rather than the unaltered sequence. The truck layer thus modifies the data pertaining to the sequence of truck ID's received in a manner to display it with the associated truck first, in a highlighted manner in this specific case, and the rest of the sequence afterwards. The modification includes associating sequence information to each one of the truck IDs in the list (1, 2, 3, etc.), and moving the truck ID associated to the current truck computer to the first place in the displayed list. This approach was found more convenient than displaying the truck IDs in a list corresponding to the order of the original sequence in some embodiments. The truck driver can easily determine his/her position in the queue by looking at the number which is in the highlighted row bearing his/her truck ID. This determination can be made easier by highlighting the row and/or by adding a suitable icon (e.g. a person icon in this case) to the corresponding row. Additionally to the load queue, additional information is provided in this example: the lane and the position are indicated at the top of the list, and a time of last update is also displayed. Displaying the time of the last update can be beneficial to the driver who wonders whether the list is still up-to-date, since connectivity issues may in some situations delay the update. In alternate embodiments, the sequence of truck IDs can be listed in accordance with the order of truck IDs in the queue rather than pulling the corresponding truck ID to the first position. It will be noted here that pulling the associated truck ID to the first position is made possible by having access to the associated truck ID. In one embodiment, the associated truck ID can be retrieved from the memory of the truck computer. In another embodiment, the associated truck ID can be communicated with the load queue order by the coordinator computer, and in such another embodiment, it is possible for the coordinator computer to perform a function of modifying the data received from the batch panel in a manner to suit specific needs, such as pulling the associated truck ID from the queue to display it in the first position.

To highlight or otherwise modify one of the truck identifiers, a given truck computer has to know to which truck identifiers it is associated to. In some embodiments, each truck computer includes a truck application stored on a memory of the truck computer and the truck application may require a driver authentication to gain partial or full access to the truck application. For instance, access to the truck application can be authorized upon validating driver credentials inputted via the input device. In these embodiments, the truck driver may enter a username and a password, or other driver credentials, via the input device of the truck computer. Upon such credential entry, the driver credentials can be validated against an accessible database. The database may be stored on a memory of the truck computer. However, and more preferably, the validation of the driver credentials can involve the coordinator computer. More specifically, the coordinator computer may have a central, accessible database of authorized truck drivers listing driver identifiers and corresponding driver credentials. In these embodiments, upon credential entry via the truck computer, the driver credentials are transmitted to the coordinator computer for validation which includes a step of comparing the inputted driver credentials to the database of authorized truck drivers and a step of transmitting an authorization signal (or error signal) to the corresponding truck application based on the step of comparing. In this way, the coordinator computer can keep track of which driver is operating which mixer truck at any given time. In some other embodiments, the truck identifier may be encoded or otherwise stored into a memory of the truck computer. In some embodiments, a truck driver may input his/her truck identifier using the input device as he/she is driving at the beginning of a work shift. More importantly, when applied to a whole fleet of mixer trucks, such a log in procedure can enhance the display of the current sequence of truck identifiers by also displaying the name of the other truck drivers proximate to their respective truck identifiers. Names of the other truck drivers in the sequence can also be displayed, which can be convenient in situations where one truck driver would want to reach another truck driver for any given reason.

It is noted that, in this specific embodiment illustrated in FIGS. 9A and 9B, a graphical user interface of the truck application is divided into a number of portions or “cards.” Each card is used to display different information that can be relevant to the truck driver at timely moments during his/her work shift. For instance, one card shows an ongoing message discussion with the coordinator computer and/or with other truck drivers, another card shows the current sequence of truck identifiers, another card shows a GPS navigation app, or push to talk navigation options, which can show and update an itinerary to the batch plant and/or to the job site in real time, and optionally showing hotspots or geographical gates, and another card shows a call history and the like. It is understood that these cards can be customized as desired. The truck application can be configured to allow the truck driver to manipulate the cards and change their order.

In this specific embodiment, a detailed load queue view may appear, such as the one shown in FIG. 9B. In this detailed load queue view, other information concerning the loading operation may be displayed. Such loading information can be received from the coordinator computer which received it from the producer computer. For instance, as shown, the displayed loading information can include a time of loading, an estimated time until loading, a queue ranking, a timestamp of when was the last sequence updated, and the like. An even more detailed view of the current sequence of truck identifiers is also displayed.

In an embodiment presented in FIG. 9C, icons associated to communication can be provided proximate to each one of the other truck identifiers for which communication data is available. When actuated, these icons can initiate a point-to-point communication channel with the other truck drivers. The communication channel may be a messaging channel or a vocal channel, for instance. In embodiments where vocal channels are preferred, radio-like communication using data lines such as Zello™ can be satisfactory, especially when batch plants and/or job sites are located far away from cellular communication towers. The truck application can also have a batch plant communication button which when actuated opens a communication channel (e.g., messaging channel, vocal channel) to the batch plant operator associated to the batch panel. This detailed load queue view can also have an update button which can force a query to the coordinator computer for an updated sequence of truck identifiers. This interface also shows notifications alerts which indicate whether the truck computer has received new messages or if the current sequence of truck identifiers has been updated. Clicking these notification alerts may force the truck application to go back to some of the cards, e.g., the cards showing ongoing message discussion or the card showing the sequence of truck identifiers, of the home page view of the truck application.

In some embodiments, other data than the sequence of truck identifiers may originate from the batch panel. Indeed, in some cases, concrete recipes can include a combination of ingredients to be mixed and delivered by the batch plant. The recipe information may be stored in memory local to the batch plant. In some other embodiments, the recipe may include not only a combination of ingredients to be mixed an delivered by the batch plant, but also additional ingredient information pertaining to one or more additional ingredient which is to be handled via the collaboration of the truck driver him/herself. In some cases, this additional ingredient information may be available to the producer, and possibly available to the producer computer. One way of communicating the additional ingredient information to the truck driver is for the batchperson communicating over a radio or simply by shouting to a truck driver which was in the vicinity of the load board. It will be understood that such a method of communication was prone to potential errors or delays. It was found that a more convenient way of communicating this additional ingredient information could be to piggyback it onto the sequence of truck identifier information when communicating the sequence of truck identifier information from the batch plant to the coordinator computer. This then allows the coordinator computer to further relay the additional ingredient information to the truck computer. The truck software can then be provided with a functionality to determine when such additional ingredient information is associated to the current ticket, and to display this on the display screen.

In the specific embodiment presented in FIGS. 9C and 9D, the presence of such additional ingredient information is signaled to the driver by the presence of an icon, provided here in the form of an exclamation mark in the row displaying the corresponding truck's identifier and place in the queue, but it will be understood that another suitable icon can be used instead. The presence of this icon can signal to the truck driver that he/she can do something useful while waiting in the queue at the batch plant for instance. In this specific example, to access the detailed information of the additional ingredient(s) to manually add to the truck, the truck driver can interact with the associated icon, which can trigger the opening of a window such as presented in FIG. 9D. The opened window can present the additional ingredient information in the same way as this information originated at the batch plant, ensuring that the message is not deformed or misunderstood due to the means of communication used to convey it. In some embodiments, there can be multiple messages to the driver for multiple additional products. Indeed, in some cases, while the details of the recipe originally received by the coordinator computer from the buyer computer may include all ingredients, the coordinator computer may not have any means to dissociate the ingredients which will be mixed in by the batch plant from the ingredients which the truck driver needs to mix in him/herself, and this information may only be available if received from the batch plant. A highly convenient way of communicating this information from the producer computer to the coordinator computer can be as presented above, i.e. to combine the associated data with the data pertaining to the details of the load queue. This data may then be sent by the coordinator computer to all the truck computers listed in the associated load queue, and software at the truck computers can be used to display the icon when additional ingredient information is associated to it's associated truck ID. Alternately, the coordinator computer may relay the data containing the additional ingredient information only and specifically to the truck computer bearing the truck ID to which the additional ingredient information is associated, together with the load queue information for which the truck ID is concerned. Either way, it can be relevant for the data containing the additional ingredient information to remain associated to the corresponding truck ID in the communication between the producer computer and the coordinator computer, whereas in the communication between the coordinator computer the additional ingredient information can be explicitly associated to the corresponding truck ID or implicitly associated to it, e.g., by being communicated solely to the truck computer bearing the corresponding truck ID. Additional ingredients to be added by the truck driver him/herself can include fiber and/or color, to name two potential examples.

The trucks can be equipped with one or more sensors, such as a location sensor (e.g., GPS) and an unloading sensor to provide two examples. Trucks can be equipped or otherwise associated to a truck computer which can be communicatively coupled to the one or more sensors in a wired or wireless manner to receive signals indicative of the measurands being sensed. As discussed above, the truck computer is generally communicatively coupled to a telecommunications network such as the Internet as well. In some embodiments, the truck computer can be provided in the form of an on-truck computer sitting in the cabin of the truck. The truck computer can be owned by an owner of the truck who may be somewhat independent from the truck driver, and/or be a computer, such as a tablet, smartphone, or smartwatch for instance, owned by the truck driver. Such a truck computer can be enabled to present options or directions to the truck driver. Such a truck computer can also be enabled to request confirmations or feedback from the truck driver and/or from devices or sensors associated to the mixer truck. Such a truck computer can also display relevant and timely information to the driver. The software used to perform the various latter functions can be referred to as the truck layer or truck application.

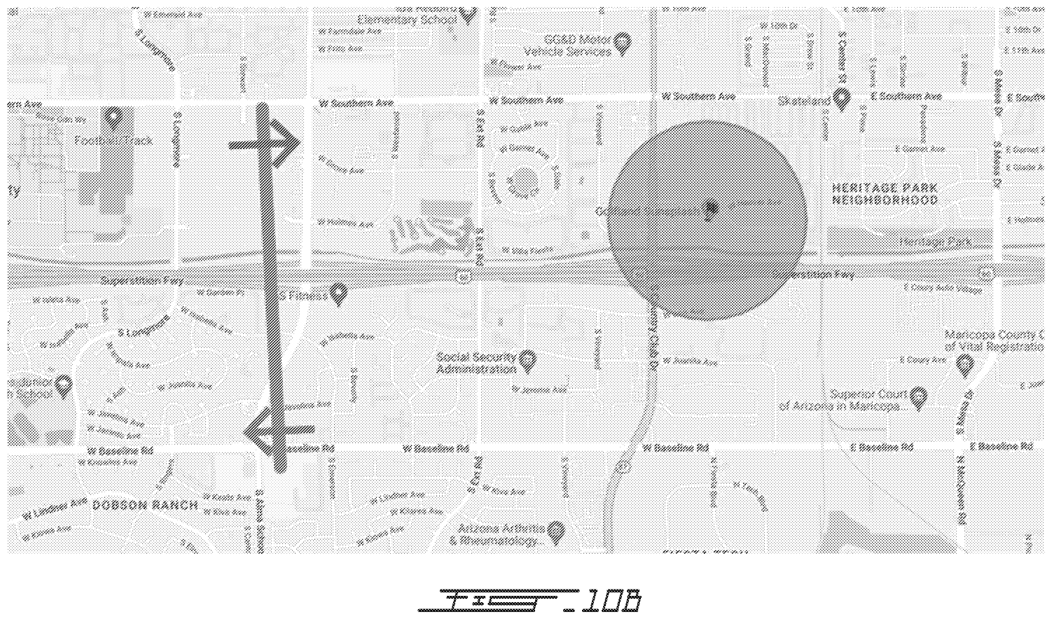

As such, the truck can have GPS sensor(s) sensing a geolocation of the truck as it travels from batching plant(s) to job site(s). In some embodiments, the truck application is provided with a software function which enables a modification of the display of the truck application based on a current geolocation of the concrete mixer truck. For instance, when a truck reaches a hotspot region such as those shown in FIG. 10A or crosses a geographical gate in a given direction such as shown in FIG. 10B, the application running on the truck computer, either directly, or via a trigger originating from the coordinator computer to which it had previously shared location information, may initiate the display of the current sequence of truck identifiers. In some circumstances, the detailed load queue view showing the sequence of truck identifiers may be prompted upon detecting that the truck computer, and corresponding truck, reached a given geographical position. Alternately, when it is detected that a truck leaves a hotspot region or crosses a geographical gate in the opposite direction, the truck application may hide the detailed load queue view, as it may no longer be relevant to the truck driver, and display the home page view of the truck application. A hotspot, sometimes referred to as a geofence, can be defined in the form of an area covering a certain range of coordinates in a coordinate system such as the one associated with GPS operation. More specifically, the geofence can be defined as an area circumscribed by a closed line. A number of geofences are presented in the embodiment shown in FIG. 10A. Such geofences can be associated to a perimeter of a batch plant premises or a region which is considered to be sufficiently close to the batch plant premises for the load queue information to be considered relevant to the truck driver. Geographical gates can be defined as a line crossing a road for instance, and a geographical gate can be considered to be triggered when a truck is detected to have crossed that line.

In another aspect, there is described a method for displaying a sequence of truck identifiers to trucks. Each truck having a respective truck identifier. The method generally has a step of, using a transmitter device communicatively coupled to a port of a batch panel, receiving a current sequence of truck identifiers from the batch panel and transmitting the current sequence of truck identifiers to a telecommunications network. Another step of, using a coordinator computer communicatively coupled to the telecommunications network, receiving the current sequence of truck identifiers from the transmitter device via the telecommunications network and relaying the current sequence of truck identifiers to truck computers each being mounted to corresponding ones of the mixer trucks. In this way, the method can include a step in which the truck computers' display screens display the current sequence of truck identifiers in real time. In some embodiments, for a given truck computer, the step of displaying includes a step of emphasizing a display of the corresponding, given truck identifier. The step of emphasizing can be performed upon determining a match between the given truck identifier and a truck identifier associated to the given truck computer. In some embodiments, the coordinator computer may transmit loading information associated to the given truck identifier for the given truck computer to display. In these embodiments, the loading information can include an estimated time of loading, an estimated time until loading, a queue rank, and the like. The step of displaying can include a step of displaying any one of the loading information bits proximate to the given truck identifier, or only when the given truck identifier is being selected via a user input, for instance. In some embodiments, the step of displaying is performed only after a step of authorizing driver credentials has been successfully performed. For instance, the method may include steps of receiving driver credentials, comparing the driver credentials to a database of authorized truck drivers listing truck driver identifiers and corresponding driver credentials, and comparing the inputted driver credentials to the database of authorized truck drivers. Only when a successful authentication is performed that the truck computer can provide access to the sequence of truck identifiers and/or other portions of the truck application. In some embodiments, the step of displaying is initiated or deactivated upon detecting that the truck computer has crossed a geographical gate or hotspot associated with the batch panel.

As can be understood, the examples described above and illustrated are intended to be exemplary only. Although the truck computer is described as an on-board computer, it is intended that in some embodiments the truck computer is rather elementary, with only a communication module receiving information from the coordinator computer or from the transmitter device connected to the batch panel, and a display screen displaying the current sequence of truck identifiers received directly or indirectly from the batch panel. In some embodiments, the display screen can be substituted for an auditory transducer which is configured to create audible feedback representative of the sequence of truck identifiers. In some of the embodiments described herein, the transmitter device is shown to be in wireless communication with the coordinator computer. However, in some other embodiments, the transmitter device connected to the batch panel may be in a wired communication, or a combination of wired and wireless communication with the coordinator computer. In some other embodiments, the coordinator computer can be omitted, with the transmitter device transmitting the sequence of truck identifiers directly to each one of the truck computers. In some embodiments, it is noted that the transmitter device is on premises, i.e., at the batch plant, the coordinator computer is preferably off-truck and the truck computers are preferably on-truck. Although the mixer truck example has been used in this disclosure, it is noted that the systems and methods disclosed herein can be used to dump trucks and other types of truck that need loading at a loading plant. The scope is indicated by the appended claims.

What is claimed is:

1. A method of displaying a sequence of truck identifiers at a plurality of truck computers, each truck computer having a corresponding display screen and being located at a corresponding truck, each truck computer having a respective one of said truck identifiers of the sequence, the method comprising:
at a producer computer located at the batch plant, communicating the sequence of truck identifiers to a coordinator computer remote from the batch plant over a telecommunications network;
at the coordinator computer, communicating the sequence of truck identifiers to corresponding ones of the plurality of truck computers associated to corresponding ones of the truck identifiers over the telecommunications network; and
at different ones of the truck computers, displaying the sequence of truck identifiers on an associated display screen.

2. The method of claim 1 further comprising, at the producer computer, receiving the sequence of truck identifiers from a batch panel.

3. The method of claim 2 wherein said receiving the sequence of truck identifiers from the batch panel includes receiving the sequence of truck identifiers via a serial port of the batch panel.

4. The method of claim 2 further comprising,
at the producer computer, receiving additional ingredient information from the batch panel, the additional ingredient information pertaining to at least one of the truck identifiers forming part of the sequence of truck identifiers;
at the producer computer, communicating the additional ingredient information to the coordinator computer over the telecommunications network; and
at the coordinator computer, communicating the additional ingredient information to corresponding ones of the truck computers associated to corresponding ones of the truck identifiers over the telecommunications network.

5. The method of claim 4 further comprising, at a truck computer corresponding to the at least one of the truck identifiers forming part of the sequence of truck identifiers, displaying a notification indicative of a presence of the additional ingredient information.

6. The method of claim 5 further comprising, at the truck computer, displaying the additional ingredient information in response to receiving an input from a user indicative of an interaction with the notification.

7. The method of claim 1, further comprising refreshing the display of the sequence of truck identifiers at the plurality of truck computers in real time, including:
at the producer computer, receiving an updated sequence of truck identifiers from a batch panel and communicating the updated sequence of truck identifiers to the coordinator computer;
at the coordinator computer, communicating the updated sequence of truck identifiers to corresponding ones of the plurality of truck computers; and
at the truck computers, updating the sequence of truck identifiers displayed based on the updated sequence of truck identifiers.

8. The method of claim 1 further comprising, at the coordinator computer, identifying the truck computers associated to each one of the truck identifiers forming part of the sequence of truck identifiers, and wherein said communicating the sequence of truck identifiers at the coordinator computer includes communicating the sequence of truck identifiers to each one of, and only, the truck computers associated to each one of the truck identifiers forming part of the sequence of truck identifiers.

9. The method of claim 8 wherein the producer computer is a first producer computer located at a first batch plant, and the sequence of truck identifiers is a first sequence of truck identifiers, further comprising:
at a second producer computer located at a second batch plant, communicating a second sequence of truck identifiers to the coordinator computer over a telecommunications network,
at the coordinator computer, identifying truck computers associated to each one of the truck identifiers forming part of the second sequence of truck identifiers, and communicating the second sequence of truck identifiers to corresponding ones of the plurality of truck computers associated to corresponding ones of the truck identifiers over the telecommunications network; and
at different ones of the truck computers associated to each one of the truck identifiers forming part of the second sequence of truck identifiers, displaying the second sequence of truck identifiers on an associated display screen.

10. The method of claim 1 wherein said displaying the sequence of truck identifiers on the associated display screen includes displaying a list of truck identifiers included in the sequence in a vertical series of adjacent rows, with each truck identifier of the sequence of truck identifier displayed in a corresponding one of the rows.

11. The method of claim 10 further comprising displaying the position of each truck identifier of the sequence of truck identifier in a corresponding one of the rows.

12. The method of claim 11 wherein said displaying the sequence of truck identifiers on the associated display screen includes including the truck identifier corresponding to the each truck computer in a first one of the plurality of rows, and displaying the remaining truck identifiers forming part of the sequence of truck identifiers in the remaining ones of the rows in the order in which they are in the sequence.

13. The method of claim 10 further comprising emphasizing a display of the respective one of the truck identifiers of the sequence on the display screen of the corresponding truck computer including modifying at least one of a font, a style, colour and background colour of the respective one of the truck identifiers of the sequence.

14. The method of claim 10 further comprising prompting the user to request to display additional ingredient information by displaying an interactive icon in the row displaying the truck identifier corresponding to the truck computer.

15. The method of claim 1 comprising, prior to the communicating the sequence of truck identifiers at the producer computer:
at the coordinator computer, receiving a job ticket from a buyer computer;
at the coordinator computer, associating a truck identifier and the batch plant to the job ticket; and
at the coordinator computer, communicating the job ticket to a truck computer bearing the associated truck identifier and to the batch plant over a telecommunications network.

16. The method of claim 15 wherein each truck computer has an input device, the method further comprising at the coordinator computer, authorizing access to the truck computer upon validating driver credentials inputted via the input device.

17. The method of claim 16 wherein authorizing includes transmitting the inputted driver credentials to the coordinator computer, the coordinator computer having an accessible database of authorized truck drivers listing a plurality of driver identifiers and corresponding driver credentials, comparing the inputted driver credentials to the database of authorized truck drivers and transmitting an authorization signal to the corresponding truck computer based on said comparing.

18. The method of claim 1 further comprising,
at the coordinator computer, associating truck identifiers of the sequence to truck driver identifiers,
wherein said communicating the sequence of truck identifiers to said corresponding ones of the plurality of truck computers includes communicating the truck driver identifiers to said corresponding ones of the plurality of truck computers.

19. The method of claim 17 wherein said displaying the sequence of truck identifiers on the associated display screen includes displaying the truck driver identifiers associated to corresponding ones of the truck identifiers on the associated display screen.

20. The method of claim 1 wherein each truck computer is configured for automatically displaying the sequence of truck identifiers on the display screen upon detecting that the truck computer has crossed a geographical gate.

21. A method for communicating a sequence of truck identifiers corresponding to a load queue of trucks at a batch plant to drivers of the trucks, the method comprising:
at a producer computer located at the batch plant, acquiring the sequence of truck identifiers from a batch panel located at the batch plant, via a serial wired connection between the producer computer and the batch panel; and
at the producer computer, transmitting the sequence of truck identifiers to a coordinator computer over a telecommunications network.

22. The method of claim 21 further comprising: at the producer computer, acquiring additional ingredient information from the batch panel, via the serial wired connection; and at the producer computer, transmitting the additional ingredient information together with the sequence of truck identifiers over the telecommunications network.

23. A method for communicating a sequence of truck identifiers corresponding to a load queue of trucks at a batch plant to drivers of the trucks, wherein each truck has a truck computer authenticated via a corresponding one of the truck identifiers, the method comprising: at a coordinator computer, receiving a plurality of sequences of truck identifiers from different producer computers, reading each one of the plurality of sequences of truck identifiers to determine to which truck identifier each sequence of truck identifiers pertains, and communicating each one of the plurality of sequences to each one of the truck computers authenticated via a truck identifier to which the sequence of truck identifiers pertains.
